(19) United States
(12) Patent Application Publication
(10) Pub. No.: US 2008/0127006 A1
(43) Pub. Date: May 29, 2008

(54) Real-Time Data Stream Decompressor

(75) Inventors: Gernot E. Guenther, Endicott, NY (US); Viktor S. Gyuris, Wappingers Falls, NY (US); Thomas J. Tryt, Binghamton, NY (US); John H. Westermann, Endicott, NY (US)

Correspondence Address: INTERNATIONAL BUSINESS MACHINES CORPORATION, IPLAW DEPARTMENT, 2455 SOUTH ROAD - MS P386, POUGHKEEPSIE, NY, 12601, US

(73) Assignee: INTERNATIONAL BUSINESS MACHINES CORPORATION, Armonk, NY (US)

(21) Appl. No.: 11/553,605

(22) Filed: Oct. 27, 2006

(51) Int. Cl. G06F 17/50

(52) U.S. Cl. 716/4; 703/16; 716/16

(57) ABSTRACT

Method, system, and program product for expanding the effective capacity of embedded memory by storing data in a compressed form and reading the data out with subsequent data decompression, including adaptive decompression and data conversion. The system and method for compression and decompression of HDL code between HDL code storage and HDL code processing for simulation of a device or system.

### BACKGROUND

1. Field of the Invention

The invention relates to expanding the effective capacity of embedded memory by storing data in a compressed format and reading the data out with subsequent data decompression, including adaptive decompression and data conversion.

2. Background Art

In the process of circuit design the designer first defines the design by describing it in a formal hardware description language. Such definition takes the form of a data file.

One of the subsequent phases on the road to physical realization of the design is logic verification. In the logic verification phase the logic designer tests the design to determine if the logic design meets the specifications/requirements. One method of logic verification is simulation.

During the process of simulation a soft-ware program or a hardware engine (the simulator) is employed to imitate or simulate the running of the circuit design. During simulation the designer can get snapshots of the dynamic state of the design under test. The simulator will imitate the running of the design significantly slower than the final realization of the design. This is especially true for a software simulator where the speed could be a prohibitive factor.

To achieve close to real time simulation speeds special purpose hardware accelerated simulation engines have been developed. These engines consists of a computer, an attached hardware unit, a compiler, and a runtime facilitator program.

Hardware accelerated simulation engine vendors developed two main types of engines: FPGA based and ASIC based.

A Field Programmable Gate Array (FPGA) based simulation engines employ a field of FPGA chips placed on multiple boards, connected by a network of IO lines. Each FPGA chip is preprogrammed to simulate a particular segment of the design. While these engines are achieving close to real-time speeds their capacity is limited by the size of the FPGA.

Application-Specific Integrated Circuit (ASIC) based simulation engines employ a field of ASIC chips placed on one or more boards. These chips include two major components: the Logic Evaluation Unit (LEU) and the Instruction Memory (IM). The LEU acts as an FPGA that is programmed using instructions stored in the IM. The simulation of a single time step of the design is achieved in multiple simulator steps. In each of these simulation steps an instruction row is read from the IM and used to reconfigure the LEU. The simulator step is concluded by allowing the configured LEU to take a single step and evaluate the design piece it represents.

ASIC based simulation engines need to perform multiple steps to simulate a single design time step hence they are inherently slower than FPGA based engines, though the gap is shrinking. In exchange, their capacity is bigger.

ASIC based simulation engines need to perform multiple steps to simulate a single design time step hence they are inherently slower than FPGA based engines, though the gap is shrinking. In exchange, their capacity is bigger.

ASIC based simulation engines need to perform multiple steps to simulate a single design time step hence they are inherently slower the FPGA based engines, though the gap is shrinking. In exchange, their capacity is bigger.

Hardware accelerated ASIC simulator engines are special purpose massively parallel computers. They employ a field of special purpose ASIC chips designed to evaluate pieces of the design under test in parallel. These chips are made up of two major parts: the Instruction Memory (IM) and the Logic Evaluation Unit (LEU). The IM stores the program that represents the assigned piece of the design. In the course of the simulation that program is read out from the IM in a sequential manner and fed to the LEU. The LEU, upon receiving the instruction from the IM, will imitate the action of the assigned piece of design.

The capacity of an embedded memory unit, such as the Instruction Memory (IM) can be extended by storing the data in a compressed form. To read such a compressed data, a decompressor unit needs to be employed.

A hardware solution for decompression was suggested in the article E.G. Nikolova, D. J. Mulvaney, V. A. Chouliaras, J. L. J. L. Nú n̅z, ‘A Novel Code Compression/Decompression Approach for High-performance SoC Design’, IEE Seminar on SoC Design, Test and Technology, Cardiff University, Cardiff, UK, 2 Sep. 2003.

The solution proposed by Nikolova et al. is not usable for implementations that require—extremely high throughput (needed 400 Gbit/sec, implementation achieved 100 Mbit/sec), a constant decompression speed, a small implementation size, and a small delay.

The IM stores the program that represents the assigned piece of a design. In the course of the simulation that program is read out from the IM in a sequential manner and fed to the LEU. The LEU, upon receiving the instructions from the IM, will simulate the action of the assigned piece of design.

The effectiveness (speed, capacity) of the hardware accelerated ASIC simulator engine is greatly influenced by the size of the pieces of the design under test that are assigned to a single simulator chip or chip set. The bigger these pieces are, the more effective the simulator is. The physical size of the IM is limited by technology constraints. It is desired to store more instructions in an IM utilizing compression. Many of these factors are bound by technology constraints.

Clearly, a need exists to increase capacity of an ASIC based hardware accelerated simulation engine.

### SUMMARY OF INVENTION

The capacity problem is obviated by the method, system, and program product of our invention. Specifically the method, system, and program product provide decompression of the hardware design language (HDL) between the Instruction memory (IM), also referred to as a memory module, and the Logic Evaluation Unit (LEU), which may be one or more individual ASIC chips. The IM stores a highly compressed HDL program. The HDL program represents an assigned piece of the design for simulation and testing. In the course of the simulation that program is read out from the IM in a sequential manner and fed to the LEU. The LEU, upon receiving the instructions from the IM, will simulate the action of the assigned piece of design.

The following special features are implemented in out solution:

The compressor may be implemented in hardware or in a software program.

The compressed data is stored in the IM and then read multiple times.

The statistical properties of the data (the instruction stream) are known and the compressor/decompressor can take advantage of it.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a high level schematic of an implementation of our invention showing a host computer connected to a simulation engine. The illustrated simulation engine has a memory module, a decompressor, and interconnect from the decompressor to ASIC chips used for rapid simulation, with ASIC outputs going to a host bus and host interface.

FIG. 2 is a high level schematic of an implementation of the decompressor. The decompressor is between a memory module and an interconnect to the ASIC chips. The illustrated decompressor includes a compressed data buffer, a look-up table, a serializer, and a decompressed data buffer array.

FIG. 3 illustrates the inner structure of the decompressor with the serializer interposed between the lookup table and the decompressed data buffer array.

FIG. 4 illustrates a further aspect of the inner structure of the decompressor with the decompressed data buffer interposed between the serializer and the interconnect to the ASIC chips.

### DETAILED DESCRIPTION

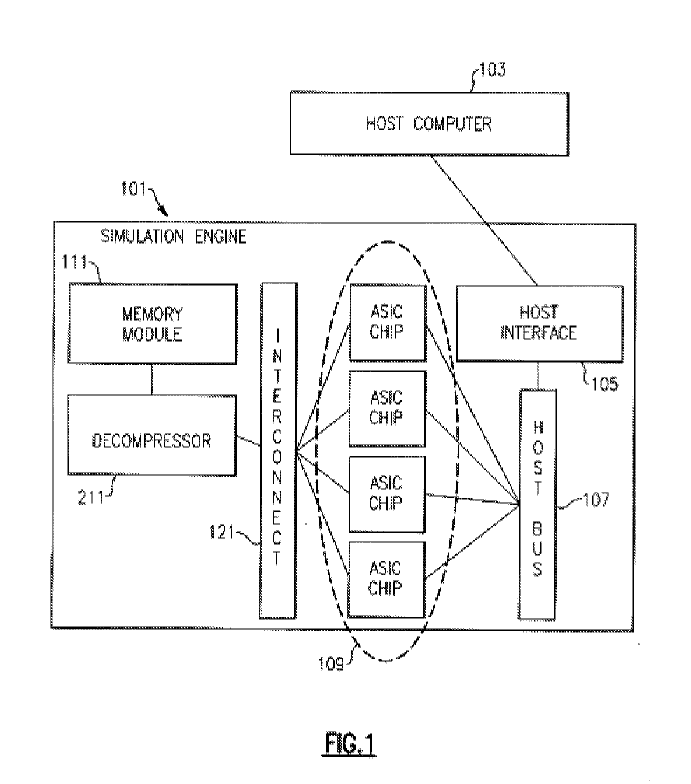

FIG. 1 is a high level schematic of an implementation of out invention showing a host computer 103 connected to a simulation engine 101, driving the simulation engine 101, and receiving output from the simulation engine 101. The illustrated simulation engine 101 has a memory module 111, a decompressor 211, and interconnect 121 from the decompressor to ASIC 109 chips used for rapid simulation, with ASIC outputs going to a host bus 107 and a host interface 105 and back to the host computer 103.

In operation, the method, system, and program product of the invention may be implanted in a simulation engine 101 for a hardware description language simulation of a digital circuit. This comprises a memory module 111 for storing a compressed hardware description language model of a digital circuit, a decompressor 211 for decompressing the compressed hardware description language model of the digital circuit, an interconnect 121 from the decompressor 211 to ASIC chips 109 for running the hardware description language simulation, and a host bus 107 and host interface 105 between the ASIC chips 109 and a host computer 103 for sending test vectors to the ASIC chips 109 and receiving output therefrom.

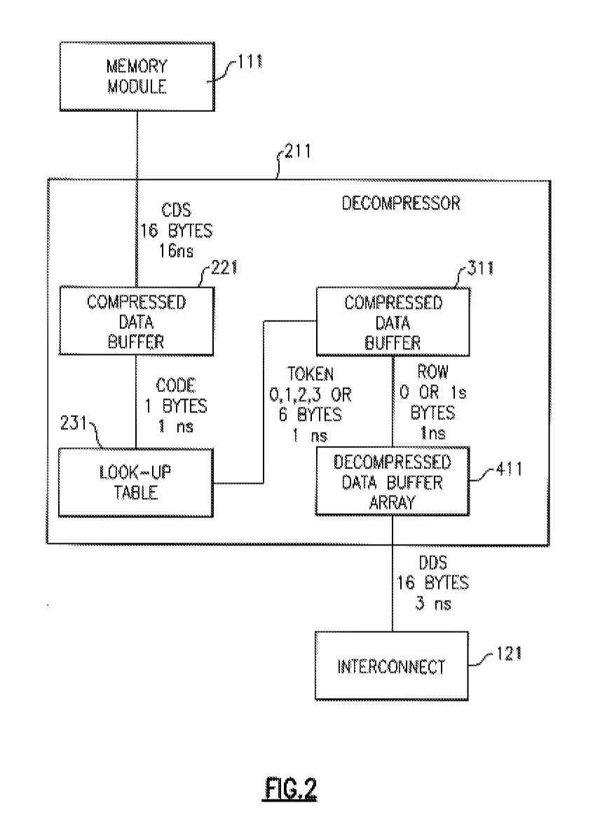

FIG. 2 is a high level schematic of an implementation of the decompressor 211. The decompressor 211 is between a memory module 111 and an interconnect 121 to the ASIC chips 109. The illustrated decompressor 211 includes a compressed data buffer 221, a look-up table 231, a serializer 311, and a decompressed data buffer array 411.

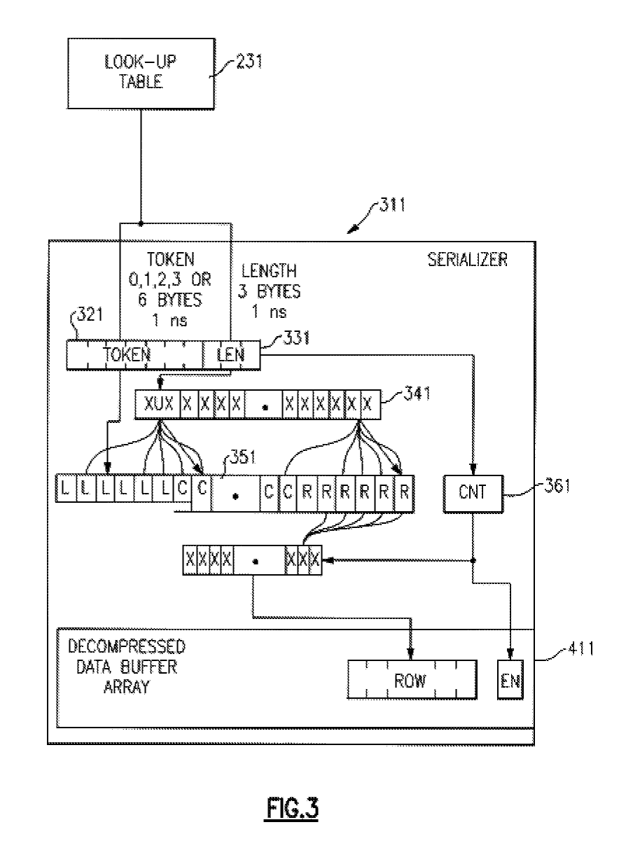

FIG. 3 illustrates the inner structure of the decompressor 211 with the serializer 311 interposed between the lookup table 231 and the decompressed data buffer array 411.

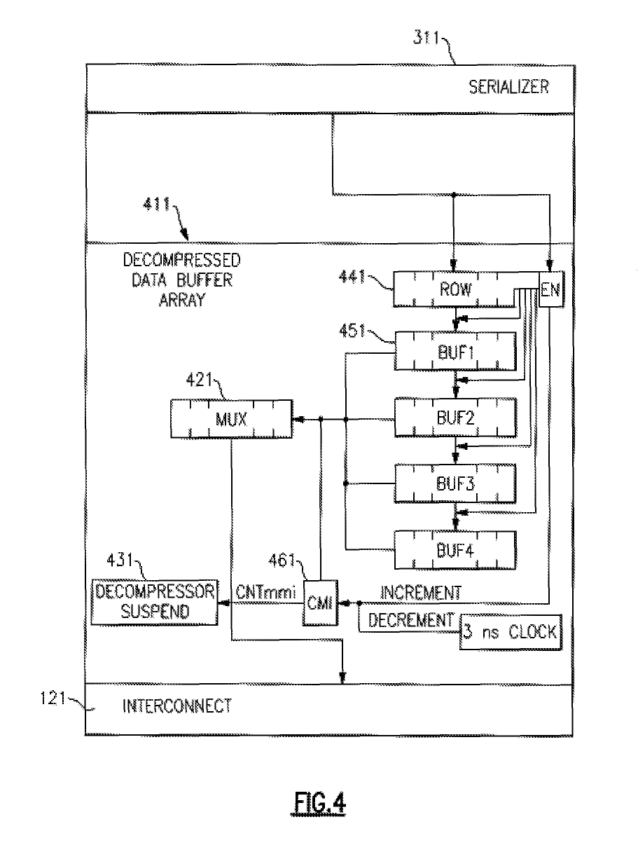

FIG. 4 illustrates a further aspect of the inner structure of the decompressor 211 with the decompressed data buffer 411 interposed between the serializer 311 and the interconnect 121 to the ASIC chips 109.

Using the statistical properties of the data, a set of 255 tokens is derived. Each token is of length 1, 2, 3, or 6. A unique code is assigned to every token. The compressor replaces every token found in the instruction stream by its corresponding code. The special code ‘0xff’ is inserted before every byte that was not part of a token (and was not replaced by a code). This compression technique, called fixed library Huffman coding, is standard in the industry.

The hardware decompressor 211 employs a look-up table 231 to translate codes to tokens and a set of shifting buffers 351 to collect decompressed data and allow constant speed decompression.

A look-up table 123 is modeled containing only constant entries with an actual size of the look-up table 231 being only 542 logic gates. The total size of the decompressor unit is approximately equal to the size of a 128*128 array. In one implementation, the IM 111 is a plurality of many smaller memories. This is advantageous in order to read massive amounts of data in a short period of time. Each of those memories is equipped with a dedicated decompressor unit.

The compressed data stream (CDS) is taken from the IM 16 bytes at a time (an IM row) and passed to a decompression unit (DU) 211 to expand it. The DU 211 stores the data in an internal compressed data buffer 221 (CDB). The CDB 221 is read one byte at a time, the byte is passed to the look-up table (LUT) 231 that translates the code the corresponding token. The length of the token is 0, 1, 2, 3 or 6 bytes. The token is passed to the serializer 311 that collects the tokens in a shifting buffer 351. To eliminate the uncertainty of the decompression time, the uncompressed data is stored in an array of decompressed data buffers 411 (decompressed data buffer array) (each one of them is of size 16 bytes) internal to the DU. Finally, data is taken out from the decompressed data buffer array 411 at a constant speed in a first-in-first-out manner. The stream of decompressed data (DDS) is the output of the DU 211.

The Serializer 311, illustrated in FIG. 3, employs shifting buffers 351 (SB) of length 6+16+6 bytes. The output of the LUT 231 is stored in the leftmost 6 bytes of the SB 351. After the code is stored a complete SB 351 is shifted to the right by 0, 1, 2, 3 or bytes (0, 8 16, 24 or 48 bits). This action is achieved by employing a 5−>1 multiplexer 341 for every bit of the rightmost 16+6 bytes of the SB. The multiplexers' input lines are the bits of the SB 351 that are 0, 8, 16, 24 or 48 bits to the left. The selector values are shared by all the multiplexers: these are the 3 bits read from the LUT 231 that encode the length 331 of the read code.

The Serializer 311 illustrated in FIG. 3 employs two counters: an SB size counter 361 and the decompressed data buffer array active buffer counter.

The SB size counter 361 records the number of bytes stored in the SB 341. It is initialized to 0, and updated by the number of bytes the LUT 231 passes to the Serializer. If the SB size counter 361 reaches 16, a flush is triggered.

FIG. 4 illustrates a further aspect of the inner structure of the decompressor with the decompressed data buffer 411 interposed between the serializer 311 and the interconnect 121 to the ASIC chips 109. At the event of flush, the content of every buffer 441 of the decompressed data buffer array 411 is be copied into the next buffer of decompressed data buffer array simultaneously, 16 bytes are copied from the SB 341 to the first buffer of the decompressed data buffer array, and 16 is subtracted from the SB-size counter 461. Furthermore, the decompressed data buffer array active buffer counter is incremented.

The decompressed data buffer array active buffer counter 461 is initialized to 0 at beginning of the decompression process, is incremented in the event of a flush as described above, and is decremented when a buffer of decompressed data buffer arrays written out to DDS. This latter event happens regularly, once in every 8 ns. The buffer that is written to the DDS is selected by the decompressed data buffer array active buffer counter.

If a flush occurs when the decompressed data buffer array active buffer counter is 4 (overflow event), then the operation of the DU is suspended for 8 ns. If the decompressed data buffer array active buffer counter is 0 when the regular DDS write occurs (underflow event), then an error flag is raised. The software compressor produces such a CDS where no underflow event will happen in the course of decompression.

The circuit diagrams depicted herein are just examples. There may be many variations to these diagrams or the steps (or operations) described therein without departing from the spirit of the invention.

The capabilities of the present invention can be implemented in hardware. Additionally, the invention or various implementations of it may be implementation in software. When implemented in software, at least one program storage device readable by a machine, tangibly embodying at least one program of instructions executable by the machine to perform the capabilities of the present invention can be provided by the program code.

The invention may be implemented, for example, by having the system and method for compression and decompression of HDL code between HDL code storage and HDL code processing for simulation of a device or system. The compression and decompression may be carried out in a dedicated processor or set of processors, or in a dedicated processor or dedicated processors with dedicated code. The code executes a sequence of machine-readable instructions, which can also be referred to as code. These instructions may reside in various types of signal-bearing media. In this respect, one aspect of the present invention concerns a program product, comprising a signal-bearing medium or signal-bearing media tangibly embodying a program of machine-readable instructions executable by a digital processing apparatus to perform a method for having the system and method for compression and decompression of HDL code between HDL code storage and HDL code processing for simulation of a device or system as a software application and thereby implement a system for compression and decompression of HDL code between HDL code storage and HDL code processing for simulation of a device or system.

This signal-bearing medium may comprise, for example, memory in a server. The memory in the server may be non-volatile storage, a data disc, or even memory on a vendor server for downloading to a processor for installation. Alternatively, the instructions may be embodied in a signal-bearing medium such as the optical data storage disc. Alternatively, the instructions may be stored on any of a variety of machine-readable data storage mediums or media, which may include, for example, a “hard drive”, a RAID array, a RAMAC, a magnetic data storage diskette (such as a floppy disk), magnetic tape, digital optical tape, RAM, ROM, EPROM, EEPROM, flash memory, magneto-optical storage, paper punch cards, or any other suitable signal-bearing media including transmission media such as digital and/or analog communications links, which may be electrical, optical, and/or wireless. As an example, the machine-readable instructions may comprise software object code, compiled from a language such as “C++”, Java, Pascal, ADA, assembler, and the like.

Additionally, the program code may, for example, be compressed, encrypted, or both, and may include executable code, script code and wizards for installation, as in Zip code and cab code. As used herein the term machine-readable instructions or code residing in or on signal-bearing media include all of the above means of delivery.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

We claim:

1. A simulation engine for a hardware description language simulation of a digital circuit comprising:
a) a memory module for storing a compressed hardware description language model of a digital circuit;
b) a decompressor for decompressing the compressed hardware description language model of a digital circuit;
c) an interconnect from the decompressor to ASIC chips for running the hardware description language; and
d) a host bus and host interface between the ASIC chips and a host computer sending test vectors to the ASIC chips and receiving test output therefrom.

2. The simulation engine of claim 1 wherein said decompressor comprises:
a) a compressed data buffer;
b) a look-up table for associating a token to an element of hardware description code;
c) a serializer; and
d) a decompressed data buffer array; and
the decompressor is in series between the memory module and an interconnect to the ASIC chips.

3. The simulation engine of claim 2 wherein said serializer comprises:
a. look up table means for Huffman encoding the hardware description language code into tokens with a unique code assigned to each token; and
b. a set of shifting buffers to decompress and collect the data.

4. The simulation engine of claim 1 comprising:
a) a memory module for storing a compressed hardware description language model of a digital circuit;
b) a decompressor for decompressing the compressed hardware description language model of a digital circuit said decomprising:
i) a compressed data buffer;
ii) a look-up table for associating a token to an element of hardware description code;
iii) a serializer, said serializer comprising look up table means for Huffman encoding the hardware description language code into tokens with a unique code assigned to each token; and a set of shifting buffers to decompress and collect the data; and
iv) a decompressed data buffer array; and
the decompressor is in series between the memory module and an interconnect to the ASIC chips;
c) an interconnect from the decompressor to ASIC chips for running the hardware description language; and
d) a host bus and host interface between the ASIC chips and a host computer sending test vectors to the ASIC chips and receiving test output therefrom.

5. A method of simulating a digital circuit design in a simulator having an instruction memory and a logic evaluation unit comprising the steps of:
a) storing a compressed hardware description language file of the digital circuit design in the instruction memory;
b) decompressing the hardware description language file;
c) processing the decompressed hardware description language file in the logic evaluation unit; and
d) recovering simulation output from the logic evaluation unit.

6. The method of claim 5 wherein decompressing the hardware description language file comprises the steps of:
a) passing compressed hardware description language code to a compressed data buffer;
b) transforming the compressed hardware description language code to tokens;
c) serializing the tokens to decompress the serialized hardware description language code to form decompressed hardware description language code;
d) storing the decompressed hardware description language code in a decompressed data buffer array; and
e) providing contents of the decompressed data buffer array as the input to the logic evaluation unit.

7. The method of claim 5 comprising the steps of:
a) storing a compressed hardware description language file of the digital circuit design in the instruction memory;
b) decompressing the hardware description language file by:
i) passing compressed hardware description language code to a compressed data buffer;
ii) transforming the compressed hardware description language code to tokens;
iii) serializing the tokens to decompress the serialized hardware description language code to form decompressed hardware description language code;
iv) storing the decompressed hardware description language code in a decompressed data buffer array;
v) copying the content of buffers in the decompressed data buffer array into a next buffer of the decompressed data buffer array; and
vi) providing contents of the decompressed data buffer array as the input to the logic evaluation unit;
c) processing the decompressed hardware description language file in the logic evaluation unit; and
d) recovering simulation output from the logic evaluation unit.

8. A computer program product comprising a computer readable media having computer readable code thereon to configure and control a simulator, said simulator having an instruction memory and a logic evaluation unit, to carry out a method of simulating a digital circuit design by a method comprising the steps of:
a) storing a compressed hardware description language file of the digital circuit design in the instruction memory;
b) decompressing the hardware description language file;
c) processing the decompressed hardware description language file in the logic evaluation unit; and
d) recovering simulation output from the logic evaluation unit.

9. The computer program product of claim 8 wherein the step of decompressing the hardware description language file comprises the further steps of:
a) passing compressed hardware description language code to a compressed data buffer;
b) transforming the compressed hardware description language code to tokens;
c) serializing the tokens to decompress the serialized hardware description language code to form decompressed hardware description language code;
d) storing the decompressed hardware description language code in a decompressed data buffer array; and
e) providing contents of the decompressed data buffer array as the input to the logic evaluation unit.

10. The computer program product of claim 8 comprising the steps of:
a) storing a compressed hardware description language file of the digital circuit design in the instruction memory;
b) decompressing the hardware description language file by:
i) passing compressed hardware description language code to a compressed data buffer;
ii) transforming the compressed hardware description language code to tokens;
iii) serializing the tokens to decompress the serialized hardware description language code of form decompressed hardware description language code;
iv) storing the decompressed hardware description language code in a decompressed data buffer array;
v) copying the content of buffers in the decompressed data buffer array into a next buffer of the decompressed data buffer array; and
vi) providing contents of the decompressed data buffer array as the input to the logic evaluation unit;
c) processing the decompressed hardware description language file in the logic evaluation unit; and
d) recovering simulation output from the logic evaluation unit.
